(19) United States
(12) Patent Application Publication
(10) Pub. No.: US 2016/0321568 A1
(43) Pub. Date: Nov. 3, 2016

(54) SYSTEMS AND METHODS FOR REDISTRIBUTING TICKETS TO AN EVENT

(71) Applicant: SMARTSEATS IP BVBA, Diegem (BE)

(72) Inventor: Jean-Sébastien Gosuin, New York, NY (US)

(21) Appl. No.: 15/105,525

(22) PCT Filed: Dec. 19, 2014
(86) PCT No.: PCT/IB2014/003210

§ 371 Date: Jun. 16, 2016

Related U.S. Application Data
(60) Provisional application No. 61/919,544, filed on Dec. 20, 2013.

(51) Int. Cl. G06Q 10/02; H04L 12/58

(52) U.S. Cl. CPC G06Q 10/02; H04L 51/36

(57) ABSTRACT

Distribution and redistribution methods and systems. A data-base stores rights allocation information, e.g., purchase or allocation records for tickets to an event. A system receives a request that may be satisfied, or partially satisfied, by reallocating rights from a first party to a second party in the database. A probability that the request will be satisfied is calculated and the party making the request receives an indication of the calculated probability. For example, some implementations include adding, responsive to receiving the request, an identifier for the second party to a queue and calculating the probability that the request will be satisfied based at least on a position of the identifier in the queue. In some implementations, a server receives a request from the second party to acquire tickets to an event, where the requested tickets must satisfy one or more conditions, e.g., location, number of seats, etc., and the server determines that the request cannot be satisfied. The server sends the requestor an invitation to join a wait-list queue and provides an indication of how likely the request is to be satisfied at a later time. In some implementations, the request is satisfied after the event begins, e.g., using tickets reclaimed from parties that do not use them. In some implementations, a rights holder determines to redistribute rights to a set of other people and invites the other people to join a queue to collect the redistributed rights. In some implementations, the system works directly with a database used for controlling admission to an event. Integration with event access control allows for real-time control and redistribution, as well as assurances of authenticity.

### TECHNICAL FIELD

The present disclosure relates to systems and methods for improving fan relations and ticket sales. In particular, the present disclosure relates to systems and methods for managing fan relations and for redistributing tickets for events, where the redistribution allows fans to use tickets that may otherwise go unused.

### BACKGROUND

It is typical for events, such as major sporting events, live music performances, and other entertainments events, to require a ticket for entry and enjoyment of the event. Because there are a finite number of seats for any given event, it is possible for a fan to be unable to purchase desirable seats or blocks of seats. Empty seats at events caused by ticket holders who do not show up can cause income loss for the event organizers and venues in the form of missed concession sales and also dissatisfaction among sponsors, which can lead to renegotiation or termination of sponsorship contracts, since the image of the sponsor is linked to the event. For example, it is undesirable to have empty seats in view of the camera for a televised event.

No-shows can also cause frustration among people who desired to attend the event but were unable to do so, e.g., because the event was sold out. Persons who are unable to purchase a ticket for an event from an event organizer or venue may resort to a secondary market for tickets to the event. However, those markets may significant inefficiencies, which manifests itself in ticket prices higher than those originally offered by the organizer or event venue.

### BRIEF SUMMARY

Using the systems and methods described herein, unused tickets to sold out events can be redistributed in real-time to persons who will use those tickets.

In some aspects, the disclosure relates to a method that includes determining, from a rights database storing rights allocation information, that a first right is allocated to a first party, and receiving a request that can be at least partially satisfied by reallocating the first right from the first party to a second party. For example, in some implementations, the request is received by a server from a client device controlled by the second party. The method includes then calculating, e.g., by the server, a probability that the request will be satisfied, and providing, e.g., to the client device, an indicator of the calculated probability. In some implementations, the method also includes recording, in a request database storing rights request information, a record of the request. For example, in some implementations, the method includes adding, responsive to receiving the request, an identifier for the second party to a queue, i.e., at a position in the queue, and calculating the probability that the request will be satisfied based at least on the position of the identifier in the queue (e.g., based on how many other people are ahead of the second party in the queue).

In some implementations, the method includes determining, after recording the record of the request, that the first party has released the first right, and updating the rights database to reallocate the first right from the first party to the second party. The method includes, responsive to successfully updating the rights database, notifying the first party that the first right has been revoked and notifying the second party that the first right has been allocated to the second party. In some implementations, the method includes voiding a ticket held by the first party. In some implementations, the method includes notifying the second party by transmitting ticket information to a client device controlled by the second party.

In some implementations, the method determines that the first party has released the first right based on receiving, from the first party, an express indicator that first party has released the first right. In some such implementations, the first party may designate one or more possible other parties to receive the first right. In some implementations, the method includes sending, to the first party, a request to confirm that the first party will exercise the first right by a specified time, and determines that the first party has released the first right when, after the specified time has passed, the first party has not yet exercised the first right. The specified time can be, for example, the start time of an event, or some amount of time after the start of an event. For example, without limitation, a number of minutes after the event starts or when a portion of the event has finished (e.g., the end of a specific period or inning of a sporting event). The specific time can be, for example, sometime between when the doors to an event venue have opened and before the event starts. For example, without limitation, 15 minutes before the event begins.

In some aspects, the disclosure relates to a system that includes at least one computer processor, one or more memory elements storing a rights database of rights allocation information and/or a request database storing rights request information, and a computer-accessible memory storing instructions that, when executed by the computer processor, cause the computer processor to determine, from the database storing rights allocation information, that a first right is allocated to a first party; receive, from a client device controlled by a second party, a request that can be at least partially satisfied by reallocating the first right from the first party to the second party; calculate a probability that the request will be satisfied; provide, to the client device, an indicator of the calculated probability; and record, in the request database, a record of the request. For example, in some implementations, the instructions cause the processor(s) to add, responsive to receiving the request, an identifier for the second party to a queue, i.e., at a position in the queue, and calculate the probability that the request will be satisfied based at least on the position of the identifier in the queue (e.g., based on how many other people are ahead of the second party in the queue).

In some implementations, the computer-accessible memory stores instructions that, when executed by the computer processor, cause the computer processor to determine, after recording the record of the request, that the first party has released the first right, and update the rights database to reallocate the first right from the first party to the second party. The system, responsive to successfully updating the rights database, notifies the first party that the first right has been revoked and notifies the second party that the first right has been allocated to the second party. In some implementations, the system voids a ticket held by the first party. In some implementations, the system notifies the second party by transmitting ticket information to a client device controlled by the second party.

In some implementations, the system determines that the first party has released the first right based on receiving, from the first party, an express indicator that first party has released the first right. In some such implementations, the first party may designate one or more possible other parties to receive the first right. In some implementations, the computer-accessible memory stores instructions that, when executed by the computer processor, cause the computer processor to send, to the first party, a request to confirm that the first party will exercise the first right by a specified time, and determine that the first party has released the first right when, after the specified time has passed, the first party has not yet exercised the first right. The specified time can be, for example, the start time of an event, or some amount of time after the start of an event. For example, without limitation, a number of minutes after the event starts or when a portion of the event has finished (e.g., the end of a specific period or inning of a sporting event). The specific time can be, for example, sometime between when the doors to an event venue have opened and before the event starts. For example, without limitation, 15 minutes before the event begins.

The details of various embodiments of the invention are set forth in the accompanying drawings and the description below.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1 is a block diagram depicting an embodiment of a network environment in which the described systems and methods operate;

FIG. 2 is a flow diagram of an embodiment of a method for queuing a person seeking tickets to an event;

FIG. 3 is a flow diagram of an embodiment of a method for confirming that a ticket holder will attend; and

FIG. 4 is a flow diagram of an embodiment of a method for determining that a ticket holder will not attend and accepting reassignment of a ticket.

FIG. 5 is a timing diagram of example interactions in an embodiment of a method for reassignment of a ticket.

FIGS. 6A-6C are flow diagrams of an embodiment of a method for determining that a ticket holder will not attend and reassigning a ticket.

FIGS. 7A-7C are example user interface displays for an example embodiment.

FIG. 8 is a block diagram of an example computing system that may be used in some embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

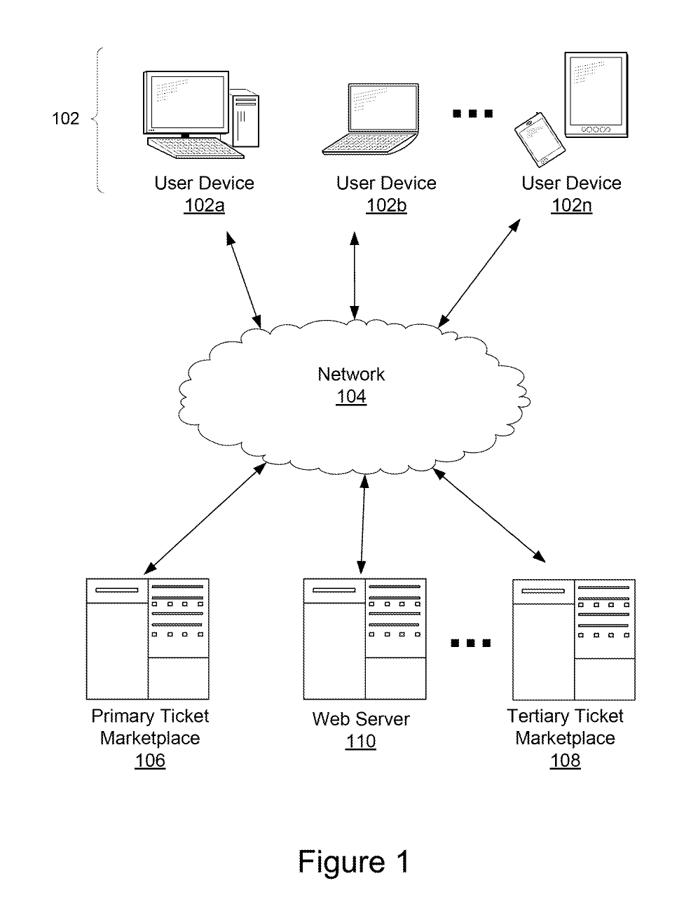

Referring now to FIG. 1, an embodiment of a network environment is depicted. In brief overview, the network environment includes one or more client devices 102a-102n (generally client devices 102) in communication with one or more remote machines via a network 104. As shown in FIG. 1, remote machines may include a primary ticket marketplace 106, a tertiary ticket marketplace 108 and a web server 110.

Although FIG. 1 shows a single network 104 between the client devices 102 and the remote machines 106, 108, and 110, the network may be formed from multiple connected networks 104. The network 104 can be a local-area network (LAN), such as a company Intranet, a metropolitan area network (MAN), or a wide area network (WAN), such as the Internet. In some embodiments, the network 104 may include a private network. In some embodiments, the network 104 may include a public network. In some embodiments, the network 104 may include a private network and a network and a public network. The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network, and a wireline network. The network may include mobile device networks utilizing any protocol or protocols used to communicate among mobile devices, including AMPS, TDMA, CDMA, GSM, GPRS, LTE, or UMTS. The network 104 may be of any such network topology as known to those ordinarily skilled in the art capable of supporting the operations described herein.

Although shown as single machines in FIG. 1, each of the primary ticket marketplace 106, the tertiary ticket marketplace 108, and/or the web servers 110 may include multiple, logically-grouped remote machines. In one of these embodiments, the grouped remote machines may be geographically dispersed. The remote machines within each group farm can be heterogeneous, that is, one or more of the remote machines or machines can operate according to one type of operating system platform (e.g., WINDOWS NT, manufactured by Microsoft Corp. of Redmond, Wash.), while one or more of the other remote machines can operate on according to another type of operating system platform (e.g., Unix or Linux). In some embodiments, the remote machines include a hypervisor or virtual machine layer. In some embodiments, the remote machines are operated by a third-party cloud services provider.

In one embodiment, remote machines may be stored in high-density rack systems, along with associated storage systems, and located in an enterprise data center. In this embodiment, consolidating the remote machines in this way may improve system manageability, data security, the physical security of the system, and system performance by locating remote machines and high performance storage systems on localized high performance networks. Centralizing the remote machines and storage systems and coupling them with advanced system management tools allows more efficient use of server resources.

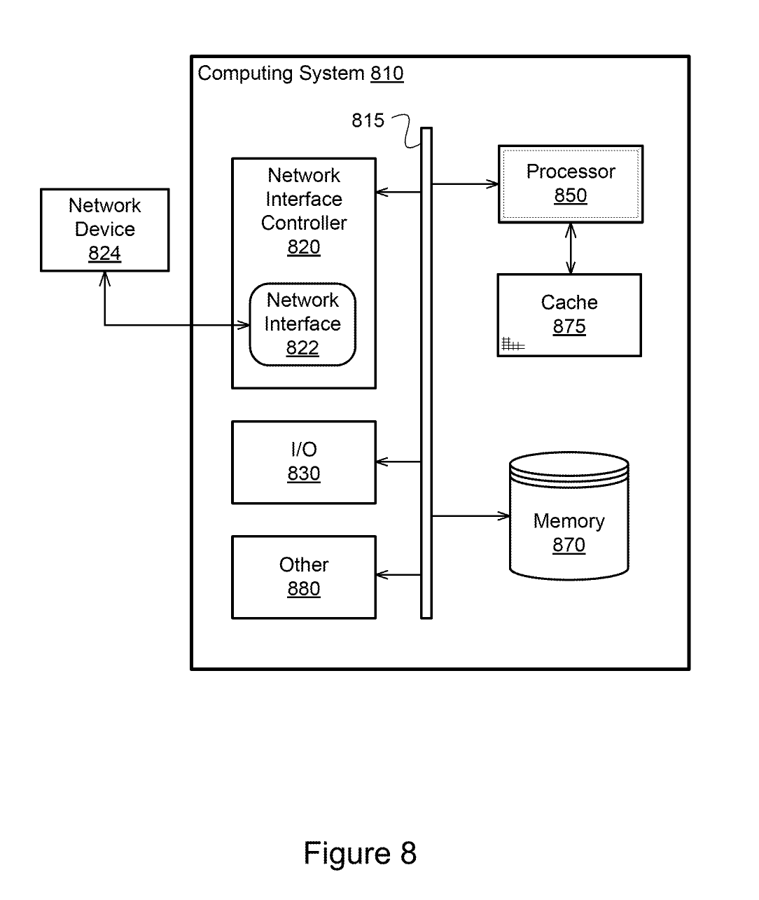

Client devices 102 and remote machines may be deployed as and/or executed on any type and form of computing device, such as a computer, network device or appliance capable of communicating on any type and form of network and performing the operations described herein. Computing devices are described in more detail below, in reference to FIG. 8.

A ticket can take many possible forms and include a variety of provisions, which are generally specified by the ticket vendor and/or local applicable laws. In general, a ticket is a license, permit, or contract that conveys, to the ticket holder, one or more rights. For example, without limitation, a ticket might include a right of entry to an event, a right to use a particular seat during the event, and the right to attend an alternative event if the event is canceled (e.g., a right to a “rain check”). The rights may be structured in the form of a permit, a contract, a lease, or as any other arrangement allowable. An event may be anything where entry or access is limited, including, for example, concerts, plays, sporting events, or any other performance events with a live audience (such as dance performances, theater, movies, contests, conferences, seminars, studio recordings, presentations, etc.), or any other occasion for which tickets might be used. In some instances, rights conveyed by possession of a valid ticket may include one or more of a right for access an event venue, a right to enter an access-controlled space, a right to park a car in a parking lot, a right to use one or more specified seats for a specified period of time, a right to acquire additional rights (e.g., a voucher), a right to receive an item, and/or a right to make a specified purchase. Similarly, a ticket may be used to convey rights not specifically associated with an event. In some implementations, a ticket may be a voucher, e.g., representing a right to some future opportunity (e.g., a right to purchase a limited-edition product when it becomes available, or a right to purchase a ticket to as yet unscheduled or tentative event). For example, a company may provide a limited edition item to the first N people to complete some qualifying action; however, if a person qualified to receive the item can't receive the item (e.g., provided an invalid address), or chooses not to receive the item, then someone who completed the qualifying action after the first N people could become eligible to receive it. In some implementations, a ticket may be representative of a reservation, such as a reservation for a hotel room, a restaurant table, a transit seat (air, train, bus, ferry, etc.), or a rental vehicle. For example, a person may want to get a last minute reservation at a popular restaurant, which might become available if someone who has a reservation does not show up. Thus the reservation was a revocable right to a table in the restaurant, which could be represented as a ticket. In general, a ticket conveys, or is representative of, a right to do or possess something such as, without limitation, to attend an event, to buy something when it becomes available, or to sit at a table in a popular restaurant.

The rights conveyed by a ticket may be revocable. In some instances, a ticket may be revoked by invalidating the ticket. Possession, in such instances, of an invalidated ticket generally conveys no rights to the possessor. In some implementations, a party whose ticket has been voided may receive a refund, a partial refund, a rain check opportunity, or some other consideration.

In some embodiments, the ticket may be a physical ticket (with or without a separable stub). In some embodiments, the ticket may be an electronic document displaying ticket information that can be used to confirm the validity of the ticket. For example, without limitation, the electronic document may include one or more of a bar code, a QR code, a scan-able image, a serial number, an encrypted string, or any other data element that may be shown at a venue ingress. In some implementations, a ticket holder may possess an electronic device (e.g., a mobile smartphone) that communicates with a ticket server, e.g., using a direct wire connection, a radio connection (e.g., Bluetooth ®), or near-field communication. Such an electronic device may present ticket credential information to a suitable reader in communication with the ticket server, and the ticket server can then validate the ticket credential information. In some such implementations, the device is an RFID chip that, when activated, provides the reader with an identifier. The ticket credential information may be stored in a database in association with the identifier such that the ticket server receives the identifier and then retrieves the associated ticket credential information from the database. In some such implementations, the identifier returned by the activated RFID chip is encrypted, and the ticket server decrypts the identifier. As used in this document, a ticket may be any of the aforementioned items or mechanisms for presenting ticket information, or any other suitable item or mechanism therefor.

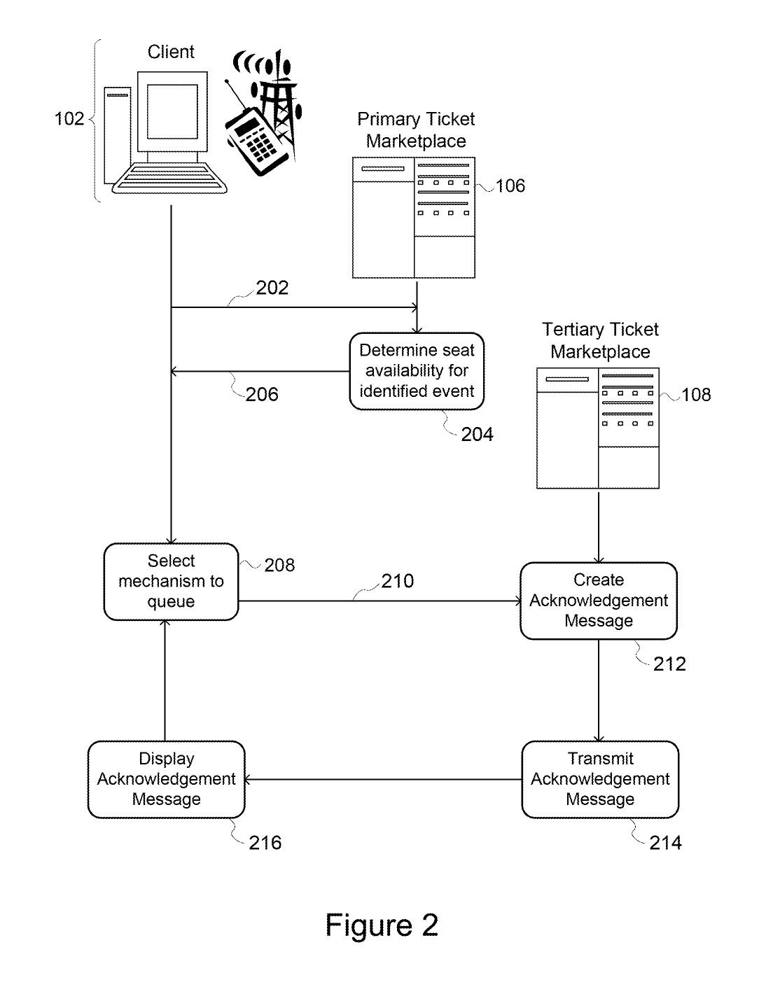

FIG. 2 depicts a flow diagram of one embodiment of the steps taken to queue a person seeking tickets to an event. As shown in FIG. 2, a client device 102 sends a ticket request to a primary ticket marketplace (step 202). The primary marketplace determines seat availability for the identified event identified (step 204) and transmits to client device 102 (step 206) a notification that the seats requested are unavailable, e.g., because the event is sold out, and providing a mechanism for joining a queue to seek unused tickets. The mechanism is selected at the client device 102 (step 208) and a message is sent (step 210) to the tertiary ticket marketplace 108. The tertiary ticket marketplace creates an acknowledgment message (step 212), and transmits it to the client device 102 (step 214), where it can be displayed by the client device (step 216). Communication and transfer of messages in FIG. 2. may occur, for example, via a network 104.

Still referring to FIG. 2, and in more detail, a client device 102 sends a ticket request to a primary ticket marketplace (step 202). For embodiments in which client device 102 is a mobile device, such as a cellular phone, smartphone, or tablet, the request may be sent directly from a native application, that is, an application designed to operate under control of the operating system of the device (e.g., Android, iOS, Windows Phone, or Ubuntu Touch). In other embodiments, the request may be generated by the client device 102 as a result of user interaction with a web page displayed in a browser. For example, a web page identifying an event may be displayed to a user together with an active element that, when selected, transmits a request to the primary ticket marketplace 106.

In some embodiments, the request may include an identification of the event and the number of tickets desired. In other embodiments, the request may also include a date. In still other embodiments, the request may identify a category of tickets in which the user is interested, e.g., dress circle, orchestra, balcony, loge, best available, lowest priced, highest priced, etc. In some embodiments, the request may be encrypted by the client device 102 before transmission to the primary ticket marketplace 106.

Still referring to FIG. 2, the primary marketplace determines seat availability for the identified event (step 204). In some instances, tickets for the event identified by the ticket request may be sold out. In some embodiments, the primary ticket marketplace determines that an event is sold out by accessing a local database storing records identifying available tickets for the event. In other embodiments, the primary ticket marketplace 106 transmits a query to the event venue or event organizer for available tickets matching any parameters provided by the user and receives a response to that query. For example, if a request specifies that a user is interested only in Dress Circle tickets, the primary ticket marketplace 106 may determine that tickets for that request are sold out, even if balcony seats are available. In some embodiments, a user specifies a block or number of contiguous seats required, and the primary ticket marketplace 106 may determine that the requests cannot be satisfied using the seats available.

The primary ticket marketplace 106 transmits a response to the client device 102 (step 206) regarding the availability of tickets. If the primary marketplace 106 has determined that tickets for the event are sold out, or that the desired tickets are unavailable, the primary marketplace 106 may include in its response a mechanism for joining a queue to seek unused tickets. For embodiments in which communication between the client device 102 and the primary ticket marketplace 106 is conducted via the Web, this mechanism can be implemented as an Active X control or JAVA code that can be embedded in the response page. For embodiments in which the client device 102 uses a specific application program to communicate with the primary ticket marketplace 106, the marketplace 106 may send a message to the application to display the mechanism to the user of the client device 102. The mechanism may be a button, pop-up window, embedded notification, text message, or email message encouraging the user to join a queue for unused tickets. In still other embodiments, the mechanism may be a redirection message that causes the client device 102 to directly access the tertiary ticket marketplace without the need for further action on the part of the user of the client device 102.

The user of the client device 102 may select the mechanism. If the mechanism is a button displayed in a web page, the user may simply click on the button. If the mechanism is a pop-up window, the user may provide any information required by the pop-up window before submitting. For example, the pop-up window may ask for the user's address information or credit card information. A text message or email message may require a particular response in order for the user to proceed.

The tertiary ticket market 106 receives an indication that the mechanism has been selected (step 212). In some embodiments, the tertiary ticket market 106 adds the user to a queue. In some embodiments, a single queue is used for the event. In other embodiments, a separate queue is used for each category of tickets. For embodiments in which multiple queues are used, the tertiary ticket marketplace may add the user to all queues when the user has selected “best available” or some other similar category of ticket.

The tertiary ticket market creates and transmits an acknowledgement message to the client device 102 (step 214) which is displayed by the client device 102 (step 216). In some embodiments, the acknowledgement message includes an indication regarding how likely it is that the user will be selected to receive an unused ticket. In some of these embodiments, the indication is made by using a color. For example, in some embodiments, green means “very likely,” yellow means “not sure,” and red means “not likely.”

The indicator to be displayed to a user can be determined using a number of algorithms. In one embodiment, historical attendance data from the venue is used to help identify whether it is likely that a queued user will receive a ticket. For example, if a venue holds 12,000 people and has a historical no-show rate of 4%, it is logical to assume that the number of no shows for an event may be 4% of 12,000, which is 480. In this example, the first people to join the queue may be given a “likely” message (up to, for example, 300 people), the next people may be given a “not sure message,” (up to, for example, the remaining 180 of the predicted 480 tickets that will become available through no-shows) and any later users may be given a “not likely” message. In some embodiments, the percentages are different from the ⅝^{ths} “likely” and ⅜^{ths} “not sure” used in this example.

In some embodiments, users who have purchased tickets to an event are asked to confirm their intent to attend the event. In some such embodiments, the users receive (e.g., via email) a message requesting confirmation at a time prior to the event (e.g., a few hours before the events starts). In some such embodiments, users confirm their intent to attend without solicitation. Users may be incentivized to confirm their intent to attend the event. For example, a user who confirms may receive a discount to a future event, coupons for use at the event (e.g., at concessions), or points in a loyalty rewards system. In some embodiments, a user who fails to confirm his intent to attend an event risks having his ticket canceled and reissued to another party. In some embodiments, a user who confirms his intent to attend, yet does not attend, is subject to a penalty. For example, a user may be charged a failure-to-attend fee or lose points in a loyalty rewards system. In some embodiments, the failure-to-attend fee is built into the original ticket purchase price, i.e., a user may receive a refund for a portion of the ticket price when that user enters the event venue.

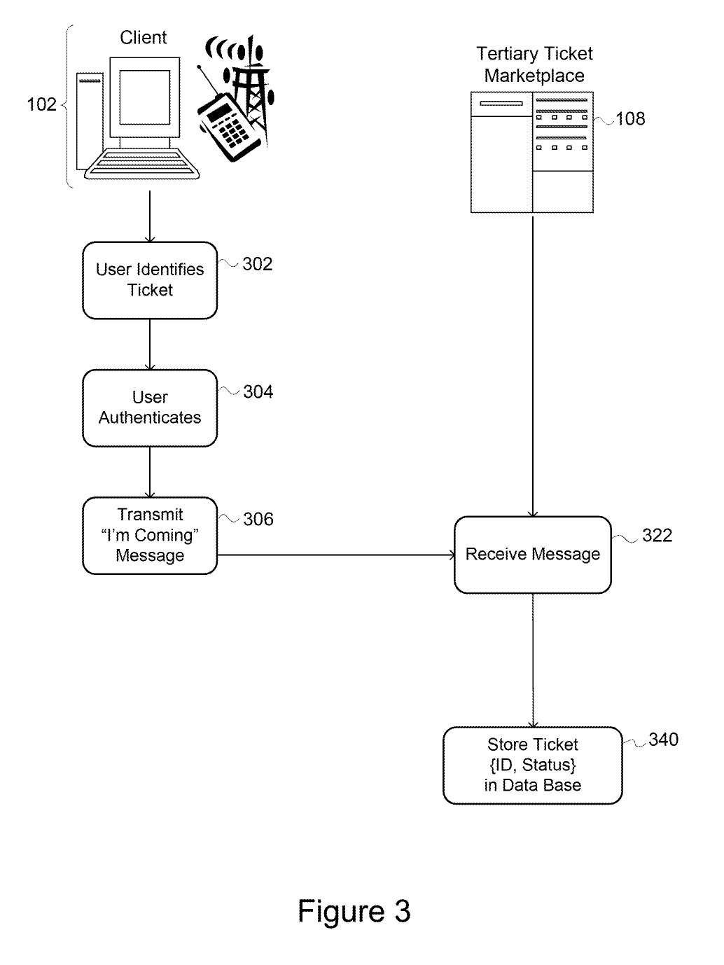

FIG. 3 depicts a flow diagram of the steps taken in one embodiment for a user to indicate that he plans to use his ticket to an event. As shown in FIG. 3, and in brief overview, a user uses a client device 102 to identify a ticket (step 302). The user also identifies or authenticates himself (step 304). The user indicates, using the client device 102, that he intends to attend the event and a message declaring that intent is transmitted to the tertiary ticket market 108 (step 306). The message is received by the tertiary ticket market (step 322) and the tertiary ticket market 108 stores the ticket identifier and the status (e.g., “definitely coming”) in a database record associated with the event (step 340). Communication and transfer of messages in FIG. 3. may occur, for example, via a network 104.

Still referring to FIG. 3, and in more detail, a user uses a client device 102 to identify a ticket (step 302) and to identify himself (step 304). These events may occur in any order. For embodiments in which client device 102 is a mobile device, such as a cellular phone, smartphone, or tablet, the user may use a native application, that is, an application designed to operate under control of the operating system of the device (e.g., Android, iOS, Windows Phone, or Ubuntu Touch). In other embodiments, the identifications may be via user interaction with a web page displayed in a browser. For example, a user may open a web page where the user logs in (or is automatically logged in, e.g., using cookies) to a user account for a ticket management service. The ticket management service then provides the user (or rather, the user's client device web browser) with a web page listing upcoming events for which the user has purchased tickets. The user selects an event. For example, the user may select an active element such as a check box or a button. In some embodiments, a user identifies a ticket using an image of the ticket. For example, a client device 102 may include a camera and the user may take an image of a physical ticket. The ticket may include a visual identifier such as a bar code or QR code. In some embodiments, the user identifies multiple tickets. In some embodiments, the multiple tickets have a ticket group identity. For example, the tickets may have been sold as a block. In some embodiments, the user identifies only a subset of tickets that were in a block of tickets. For example, a user may have purchased four tickets to an event but only intends to use two. In some embodiments, the user submits identifying information for the tickets to a ticket management service, and the ticket management service then requests the user confirm that they are the purchaser of those tickets, e.g., by supplying a password for a purchasing account, the last few digits of a credit card used to purchase the tickets, or the answer to some other authentication question.

Still referring to FIG. 3, and in more detail, a user uses a client device 102 to transmit an intent to attend an event (step 306). The client device 102 generates an “I'm Coming” message and sends this message to a ticket management service, e.g., at the Tertiary Ticket Marketplace 108. In some embodiments, the “I'm coming” message includes an identifier for the ticket (or tickets) identified in step 302. In some embodiments, the “I'm coming” message includes an identifier for the user identified in step 304. In some embodiments, a user may generate and send the “I'm coming” message at any point prior to the event. In some embodiments, a user may only send the “I'm coming” message within a specific time-frame, e.g., during the week leading up to the event. In some embodiments, a user must send the “I'm coming” message no later than a time prior to the event (e.g., thirty minutes before the event starts). In some embodiments, a ticket that has not been confirmed is subject to cancelation and reissue. In some of these embodiments, a user who transmits the “I'm coming” message after the ticket has been canceled and reissued to another party is placed in a priority queue to receive replacement tickets. In some embodiments, a user who transmits the “I'm coming” message after the ticket has been canceled receives a notification that the ticket was canceled for failure to check-in.

Still referring to FIG. 3, and in more detail, the “I'm Coming” message is received by the tertiary ticket market (step 322) and the tertiary ticket market 108 stores the ticket identifier and the status (e.g., “definitely coming”) in a database record associated with the event (step 340). In some embodiments, the database record is used to prevent the identified ticket (or tickets) from being canceled. The database record may be stored in a database (or any other kind of knowledge base). The database may be replicated. In some embodiments, a copy of the database is stored at the venue. In some embodiments, a copy of the database is stored by an admissions manager for use in allowing patrons access to the event facility.

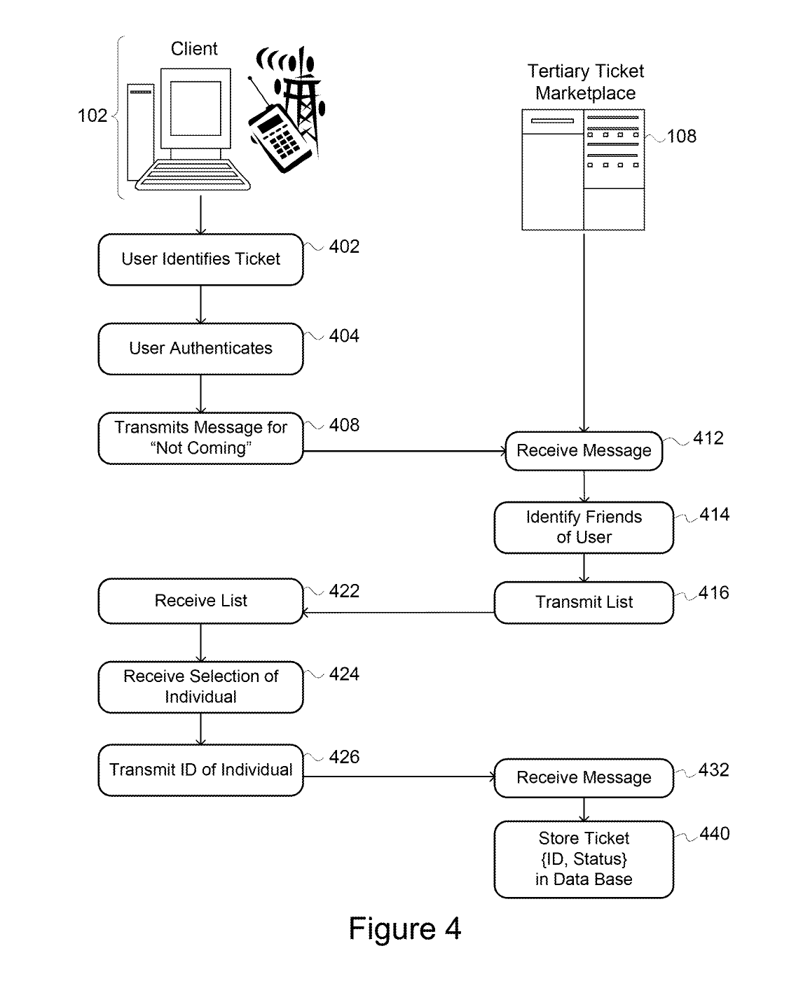

FIG. 4 depicts a flow diagram of the steps taken in one embodiment for a user to indicate that the user will not attend and that the user wishes to transfer his or her ticket (or tickets) to a friend. As shown in FIG. 4, and in brief overview, a user uses a client device 102 to identify a ticket (step 402) and to identify or authenticates himself (step 404). The user indicates, using the client device 102, that he does not intend to attend the event and a message indicating that intent is transmitted to the tertiary ticket market 108 (step 408). The tertiary ticket market 108 receives the message (step 412) and identifies a list of social contacts for the user (step 414). The tertiary ticket market 108 transmits the list to the client device 102 (step 416). The client device 102 receives the list and presents the user with an interface for selection of to whom to transfer the ticket (step 422). The client device may receive a selection of an individual from the list as a recipient for the ticket (step 424). The identification of the recipient is transmitted back to the tertiary ticket marketplace 108 (step 426). The tertiary ticket marketplace 108 receives the identification message (step 432) and stores the identification of the person, together with the ticket identifier in a database record associated with the event (step 440). Communication and transfer of messages in FIG. 4. may occur, for example, via a network 104.

Still referring to FIG. 4, and in more detail, a user uses a client device 102 to identify a ticket (step 402) and to identify himself (step 404). These events may occur in any order. These events are equivalent to steps 302 and 304 described above in reference to FIG. 3.

Still referring to FIG. 4, a user uses a client device 102 to transmit an intent not to attend an event (step 408). The client device 102 generates an “I'm Not Coming” message and sends this message to a ticket management service, e.g., at the Tertiary Ticket Marketplace 108. In some embodiments, the “Not Coming” message includes an identifier for the ticket (or tickets) identified in step 402. In some embodiments, the “Not Coming” message includes an identifier for the user identified in step 404. In some embodiments, a user may generate and send the “Not Coming” message at any point prior to the event. In some embodiments, a user may only send the “Not Coming” message within a specific time-frame, e.g., during the week leading up to the event. In some embodiments, a user may send the “Not Coming” message within the same timeframe for sending an “I'm Coming” message as described above in reference to FIG. 3.

Still referring to FIG. 4, the “Not Coming” message is received by the tertiary ticket market (step 412) and the tertiary ticket market 108 proceeds to redistribute the ticket (or tickets) identified by the “Not Coming” message. In some embodiments, the tickets are canceled and new tickets are issued to other users who are waiting in a queue. In some embodiments, as shown in FIG. 4, the tertiary ticket market 108 provides the original purchaser with the option of transferring the tickets to a friend.

Still referring to FIG. 4, the tertiary ticket market identifies a list of social contacts for the user (step 414). In some embodiments, the user has an account with the tertiary market and the account is linked to one or more other accounts, forming a social network of friends to whom the user might transfer tickets. In some embodiments, the tertiary market accesses connection data provided by a third-party social network platform (e.g., Facebook “Friends”, Linked-In “Contacts”, or Google+“Circles”). Many third-party social network platforms provide a program application interface (API) for obtaining connection data for a user. In some embodiments, the tertiary market accesses connection data provided by an e-mail provider. Many third-party email platforms provide an API for accessing a user's contact list. In some embodiments, the tertiary ticket market forms a short-list of the user's connections, where the short-list is a subset of all possible connections. Connections may be selected for inclusion in the short-list based on one or more prioritization factors and/or at random. For example, the tertiary marketplace may provide a user with ten initial options and an option for more suggestions. The ten initial options may include people to whom the user has previously transferred tickets, people to whom the user is associated on multiple social network platforms, people with whom the user interacts most frequently, and/or people who are also users of the tertiary ticket market and appear in the user's social connections or e-mail contacts.

The tertiary ticket market 108 then transmits the list (or a portion of the list) to the client device 102 (step 416). In some embodiments, the list is sent to a custom application executed by the client device 102. In some embodiments, the list is formatted as a web page and transmitted to a web browser. In some embodiments, only a portion of the list, e.g., a short list, is transmitted. In some such embodiments, the user may request transmission of an additional list. In some embodiments, the user may specify how many friends to suggest. In some embodiments, the list is empty. For example, in some embodiments, the list is only representative of friends to whom the user has previously transferred tickets, and/or from whom the user has previously received tickets. Initially, a user who has never participated in a ticket transfer (e.g., a new user) would have an empty list of friends.

Still referring to FIG. 4, the client device 102 receives the list and presents the user with an interface for selection of to whom to transfer the ticket (step 422). In some embodiments, the interface is presented as a web page at a web browser. In some embodiments, the interface is a custom application specific to the client device 102. In some embodiments, the interface includes an option for a user to specify a person not on the list. For example, the user may submit an e-mail address or a telephone number for a person. In some embodiments, the tertiary market, upon receiving an e-mail address or telephone number for a person not known to the tertiary market, will reach out to that person and invite them to join the marketplace. For example, the tertiary ticket market may generate an e-mail with a link to web page or application store, may generate a text message, or may generate an automated telephone call.

Still referring to FIG. 4, the client device receives a selection of an individual from the list as a recipient for transfer of the user's ticket or tickets (step 424). In some embodiments, the selection is responsive to presentation of the list in step 422. In some embodiments, the user may select the recipient through interaction with a list of friends displayed by the client device 102. For example, in some embodiments, a user selects a button or check box associated with the intended recipient. In some embodiments, a user enters the number of tickets to transfer. In some embodiments, each ticket in a group of tickets is transferred independently. In some embodiments, all of the tickets in a group of tickets are transferred as a block.

Still referring to FIG. 4, the identification of the selected recipient is transmitted from the client device 102 back to the tertiary ticket marketplace 108 (step 426). The tertiary ticket marketplace 108 receives the identification message (step 432) and processes the selection. In some embodiments, the tertiary ticket marketplace 108 generates a message to the identified recipients to accept or reject the transfer. In some embodiments, where the identified recipients are already in a waiting queue for the event, the tickets are transferred without waiting for the recipient to agree to the transfer. In some embodiments, where the identified recipients do not have an account with the ticket management service, the service invites the identified recipients to create an account.

Once the transfer is determined, the tertiary ticket marketplace 108 stores the identification of the new recipient, together with the ticket identifier, in a database record associated with the event (step 440). In some embodiments, the database record is used to prevent the identified ticket (or tickets) from being canceled. The database record may be stored in a database (or any other kind of knowledge base). The database may be replicated. In some embodiments, a copy of the database is stored at the venue. In some embodiments, a copy of the database is stored by an admissions manager for use in allowing patrons access to the event facility. In some embodiments, once the tickets have been transferred, the ticket manager sends the recipient a message requesting confirmation of an intent to attend.

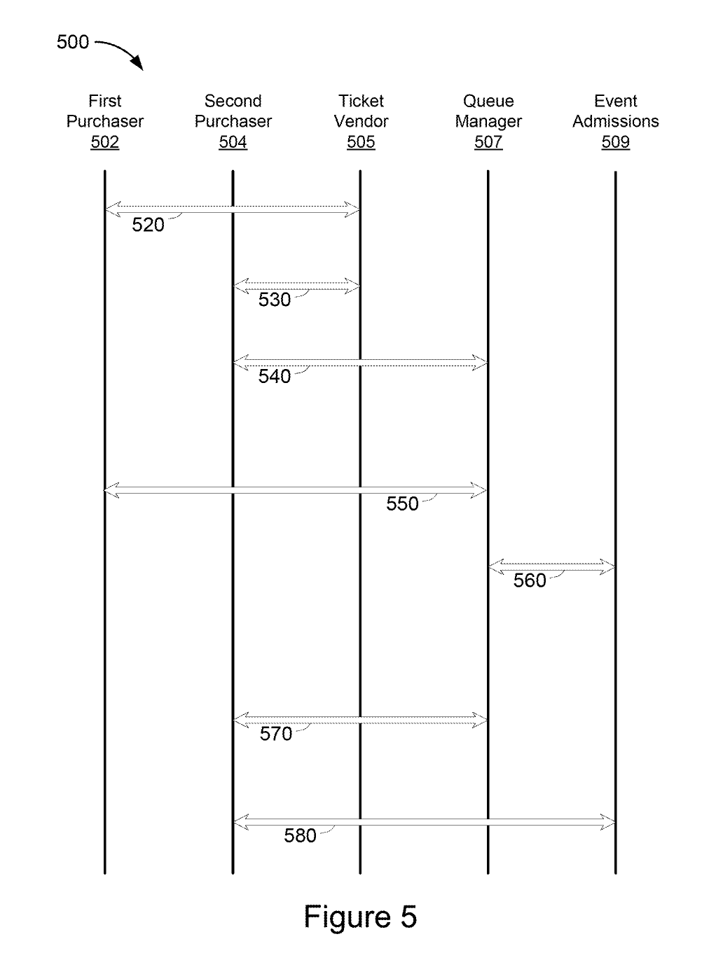

FIG. 5 is a timing diagram of example interactions in an embodiment of a method for reassignment of a ticket. In broad overview, the timing diagram 500 shows a sequence of events, starting at the top and progressing through time towards the bottom. Five participants are shown in the timing diagram 500: A first purchaser 502, a second purchaser 504, a ticket vendor 505, a queue manager 507, and an event admissions 509. These participants engage is a series of events: A first purchase interaction 520, a second purchase interaction 530, a queuing interaction 540, a cancelation action 550, a ticket revocation action 560, a ticket reissue action 570, and an admissions action 580.

Referring to FIG. 5 in more detail, a first purchaser 502 engages in a first purchase interaction 520 with a ticket vendor 505. In some embodiments, the first purchaser 502 is a user of a client device 102. In some embodiments, the ticket vendor 505 is a the official ticket broker for an event. For example, the ticket vendor 505 may be the box office for the event venue. If there are tickets available for an event, to the satisfaction of the first purchaser 502, the ticket vendor 505 issues tickets to the first purchaser 502.

In some embodiments, physical tickets are provided (e.g., mailed) to the first purchaser 502. In some embodiments, virtual tickets are issued. In some embodiments, a virtual ticket is a ticket serial number or identifier, which may be presented to the user in a graphical form, e.g., as a bar code or QR code. In some embodiments, nothing is provided to the first purchaser. For example, the first purchaser may have an account and the ticket may be issued to the account such that the purchaser need only present a credential for access to the event. In some embodiments, a government issued identification is used as a credential. In some embodiments, a bank card or credit card (e.g., a card used for the purchase) is used as a credential. In some embodiments, a custom identification is used as a credential, e.g., a card with an RFID chip on it issued by the venue. Regardless of delivery, when the first purchaser 502 purchases a ticket to an event (at interaction 520) the first purchaser has an ownership interest in a right to attend the event.

In some embodiments, when a purchaser purchases a ticket to an event, the purchaser is invited (by the ticket vendor) to register the ticket with a ticket manager. In some embodiments, there is an incentive to register the ticket with the ticket manager. In some embodiments, all tickets issued by the ticket vendor 505 must be registered with the ticket manager. In some embodiments, the purchaser 502 may register the ticket with the ticket manager without inducement from the ticket vendor 505.

Referring to FIG. 5 in more detail, a second purchaser 504 engages in a purchase interaction 530 with a ticket vendor 505. In some embodiments, the second purchaser 504 is a user of a client device 102. As shown in FIG. 5, the second purchaser 504 is unable to purchase a ticket. For example, the event may be sold out or there may not be tickets available in the number or location required by the purchaser 504. Thus, the second purchaser 504 is unable to purchase a ticket to the event. However, the second purchaser 504 may be interested in the tickets that were sold to the first purchaser 502. The second purchaser 504 is given the option of entering a waiting queue.

The second purchaser 504 enters into an interaction 540 with a queue manager 507. In some embodiments, the queue manager 507 is the tertiary marketplace 108 described above. In some embodiments, the queue manager 507 is operated by a different party than the ticket vendor 505. During the interaction 540, the queue manager 507 may provide the second purchaser 504 with an indication of the purchaser's place in the queue. In some embodiments, the queue manager 507 provides the second purchaser 504 with a prediction of how likely the second purchaser will receive tickets. In some embodiments, during the interaction 540 with the queue manager 507, the second purchaser provides bank or credit card information and the queue manager 507 places a credit hold for the ticket purchase price. The hold facilitates later rapid payment in the event of a ticket transfer. In some embodiments, the second purchaser is requested to provide bank or credit card information only if the second purchaser's place in the queue is above a threshold probability of obtaining a ticket.

Referring to FIG. 5 in more detail, the first purchaser 502 later declines to attend the event. The queue manager 507, in interaction 550, determines that the first purchaser 502 will not attend the event and releases the tickets held by the first purchaser 502 (e.g., as purchased during interaction 520). The released tickets can then be reissued to the next interested party in the queue, e.g., the second purchaser 504. In some embodiments, the queue manager 507 determines that the first purchaser 502 will not attend the event because the first purchaser 502 submits an “I'm Not Coming” message, e.g., as described above in reference to FIG. 4. In some embodiments, the queue manager 507 determines that the first purchaser 502 will not attend the event because the purchaser 502 has not confirmed an intent to come with an “I'm Coming” message, e.g., as described above in reference to FIG. 3. In some embodiments, the queue manager 507 determines that the first purchaser 502 will not attend the event because the purchaser 502 has not entered the event venue by a time respective to the event start time. For example, the ticket may be released fifteen minutes prior to the event starting. In some embodiments, purchasers in the queue with a high likelihood of obtaining tickets are encouraged to be at a location in close proximity to the venue.

Referring to FIG. 5, the queue manager 507 then revokes the tickets sold to the first purchaser 502 and notifies the event admissions 509 not to allow entry under the revoked tickets (interaction 560). In some embodiments, the event admissions operates from a database of authorized tickets. This database may be provided by the ticket vendor 505. In some embodiments, the event admissions is the same entity as the ticket vendor 505. In some embodiments, the ticket vendor 505 is a third party not directly affiliated with the venue (e.g., Ticketmaster does not operate the theaters for which it sells tickets). In some embodiments, the event admissions 509 shares the database with the queue manager 507 and the queue manager 507 can directly modify the database. When the queue manager 507 releases or cancels tickets sold to the first purchaser 502, the queue manager 507 interacts with the event admissions to ensure that the revoked tickets cannot be used to enter the venue. The seats associated with the revoked tickets are re-associated with a new ticket (or ticket serial number) and the new ticket can then be distributed to a new ticket recipient.

The second purchaser 504 is notified in interaction 570, by the queue manager 507, that the second purchaser 504 is eligible to receive, or has received, tickets to the event. In some embodiments, the second purchaser 504 must confirm the transfer. For example, it may be that the second purchaser 504 is no longer able to attend or cannot get to the venue in time. In some embodiments, the second purchaser 504 agrees in advance to receive the tickets, such that the transfer can be fully automated and (during the interaction 570) the queue manager 507 simply notifies the second purchaser 504 that the tickets have been transferred. In some embodiments, purchasers in the queue with a high likelihood of obtaining tickets are encouraged to enter a secondary venue. In some embodiments, the secondary venue has televisions or projector screens showing the event. In some embodiments, persons on the queue entering a secondary venue check-in with the secondary venue to confirm that they are available to quickly leave the secondary venue and enter the main venue if they are able to obtain tickets. In some embodiments, checking in at a secondary venue increases the likelihood of obtaining tickets. For example, the check in event may be used to increase the purchasers position in the queue, or to transfer them to a priority queue.

The second purchaser 504 then attempts to enter the venue with the transferred ticket (interaction 580). The second purchaser 504 presents the event admissions 509 with a ticket (e.g., a bar code or QR code displayed on a smart phone or other client device 102, or a credential as described above). The event admissions 509 allows entry based on the ticket presented, if the ticket corresponds to the reissue ticket negotiated with the queue manager 507.

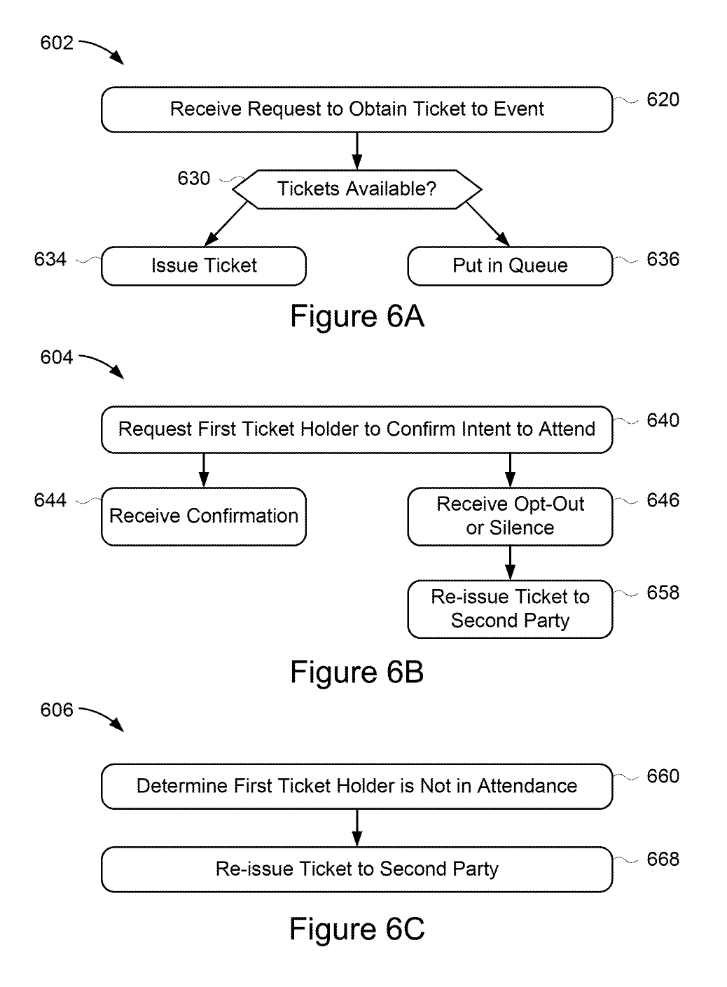

FIGS. 6A-6C are flow diagrams of an embodiment of a method for determining that a ticket holder will not attend and reassigning a ticket. In method 602, illustrated in FIG. 6A, a ticket vendor receives a request to obtain a ticket to an event (stage 620). The ticket vendor determines if tickets are available to satisfy the request (stage 630). If tickets are available, the ticket vendor issues the requested tickets (stage 634). If tickets are not available, the ticket vendor offers to place the party seeking the tickets into a waiting queue (stage 636).

Referring to FIG. 6A, in more detail, a ticket vendor receives a request to obtain a ticket to an event (stage 620). If there is a cost associated with the ticket, the request to obtain the ticket may be a request to purchase the ticket. The ticket vendor may be associated with the event venue, may be associated with a ticket wait-list queue manager, or may be an un-associated third-party. The request received identifies an event. The request received by the ticket vendor may indicate a number of seats requested, a preferred location within the venue, and/or a preferred price range. In some embodiments, the request includes an identifier for a user submitting the request. In some embodiments, the ticket vendor determines if the user is registered with the ticket wait-list queue manager.

The ticket vendor determines if tickets are available to satisfy the request (stage 630). The event may be sold out, with no tickets available. The available tickets may be in a holding state, e.g., held for VIPs but not actually purchased. Tickets may be held in a holding state for a variety of reasons, including, for example, as ticket allocations for guests of the performers, tickets provided to sponsors for redistribution through other means, or tickets held back to address last minute problems. It is also possible that available tickets might not satisfy the request. For example, the request may be for four adjacent tickets and there may not be four adjacent seats available for the event. In some embodiments, seats in close proximity but not actually adjacent may be offered to satisfy a request for adjacent seats. For example, two seats in a first row that are behind two seats in a second row may be sufficient to satisfy a request for four adjacent seats. As another example, the request may be for tickets in a specific section of the venue—tickets might not be available in the requested section even though the event itself is not sold out.

If tickets are available, the ticket vendor issues the requested tickets (stage 634). In some embodiments, the tickets are assigned a serial number and/or a ticket group number. The ticket serial numbers (or group number) are then recorded in a database record for sold tickets (or allocated tickets), in association with the event and the seats. In some embodiments, the database record includes information identifying the party acquiring the tickets (e.g., ticket purchaser) or otherwise associating the tickets with them, e.g., via a purchaser's account with the ticket wait-list queue manager. In some embodiments, the ticket vendor recommends or requests that the party acquiring the tickets register the seats with the ticket wait-list queue manager, e.g., in case they become unable to attend the event. In some embodiments, the party acquiring the tickets is required to register the tickets with the ticket wait-list queue manager.

If tickets are not available, the ticket vendor offers to place the party seeking the tickets in to a waiting queue (stage 636). If the party seeking the tickets has an account with the ticket wait-list queue manager, the party may be transferred to the ticket wait-list queue manager and immediately forwarded to a queue entry interface. If the party seeking the tickets does not have an account with the ticket wait-list queue manager, the party may be forwarded to an account creation interface for the ticket wait-list queue manager.

In method 604, illustrated in FIG. 6B, a queue manager requests that a ticket holder confirm an intent to attend an event (stage 640). The queue manager then either receives confirmation (stage 644) or determines that the ticket holder will not attend (stage 646). When the ticket holder will not attend, the queue manager re-issues the ticket to a second party, e.g., from the queue (stage 658). In method 606, illustrated in FIG. 6C, a venue admissions controller determines that a ticket holder is not in attendance (stage 660) and re-issues the ticket to a second party, e.g., from the queue (stage 668).

Referring to FIG. 6B, in more detail, a queue manager requests that a ticket holder confirm an intent to attend an event (stage 640). The ticket holder has previously registered tickets to the event and, at stage 640, the ticket wait-list queue manager ascertains if the holder is still planning to attend. In some embodiments, the queue manager sends the request via one or more of e-mail, SMS text, automated telephone call, or through a custom application notification system.

The queue manager then either receives confirmation (stage 644) or determines that the ticket holder will not attend (stage 646). In some embodiments, the queue manager receives confirmation through a response message from the ticket holder, e.g., the “I'm Coming” message described above. In some embodiments, the queue manager receives confirmation from the venue or from a gate admission authority at the venue, when the ticket holder enters the venue. If the queue manager does not receive confirmation, it is likely that the ticket holder will not attend. In some embodiments, the ticket wait-list queue manager determines that the ticket holder will not attend (stage 646) through receipt of an “I'm Not Coming” message, as described above. In some embodiments, the ticket wait-list queue manager determines that the ticket holder will not attend (stage 646) through inaction on the part of the ticket holder after one or more attempts to obtain confirmation. In some embodiments, a silent ticket holder is deemed “not coming” after a predetermined number of confirmation attempts (e.g., 3). In some embodiments, a silent ticket holder is deemed “not coming” after a deadline has passed, e.g., shortly (e.g., fifteen to thirty minutes) before or after an event starts.

When the ticket holder will not attend, the queue manager re-issues the ticket to a second party, e.g., from the queue (stage 658). In some embodiments, the original ticket is cancelled and a new ticket is issued to a party selected from the wait-list queue. A ticket may be canceled, for example, by voiding the ticket's serial number with the venue's gate authority such that the ticket cannot be used to gain entry to the event. A new ticket may be issued, for example, by generating a new ticket serial number, updating the venue's gate authority to allow entry for a ticket associated with the new ticket serial number, and issuing a ticket with the serial number. The ticket may be issued by printing a physical ticket with a bar code or QR code with the serial number. The ticket may be issued by e-mailing (or otherwise transmitting to) the recipient an electronic version of the ticket, for printing or displaying on a portable device.

In method 606, illustrated in FIG. 6C, a venue admissions controller determines that a ticket holder is not in attendance (stage 660) and re-issues the ticket to a second party, e.g., from the queue (stage 668). In some embodiments, if a ticket holder fails to attend an event, and fails to request that his or her ticket be held for late entry, then the ticket can be canceled and the seat can be released for use by another party. In some embodiments, at some period of time after the venue has opened to admit ticket holders, or after the event has started, the queue manager obtains a list of tickets that have not been used to gain entry. For example, the queue manager may access the venue's gate authority's database, or a copy of the database. The unused tickets may be canceled (or alternatively, marked as used with no allowance for re-entry). New tickets may be generated for the unused seats and (at stage 668) issued to people waiting in the queue. In some embodiments, people are removed from the queue in a first-in/first-out (FIFO) order. In some embodiments, people are removed from the queue in an order determined by additional factors such as VIP status, loyalty bonuses, willingness to pay more, or presence at a secondary venue in close proximity to the primary main venue.

In some embodiments, the ticket holder may opt to release one or more tickets for redistribution. In some such embodiments, the ticket holder can designate one or more people to have priority in receiving the tickets. For example, the ticket holder may want clients, customers, friends, or family to have an opportunity to take or purchase the tickets prior to releasing them to other people. In some embodiments, the ticket holder only releases the ticket if it is distributed to someone designated by the ticket holder for receipt. The identified people receive a message inviting them to take or purchase the ticket. In some embodiments, the message is an electronic message sent via e-mail, SMS text message, application notification, or automated telephone call. The message recipients do not need to be in the waiting queue. If none of the identified people respond within a threshold period of time, the ticket is released to the waiting queue. In some instances, e.g., where the event has not sold out or where all ticket requests have been satisfied, there is no queue. In such instances, the ticket holder may be unable to release the ticket or the ticket may be released for distribution responsive to a future request. If the ticket is sold, the ticket holder may receive proceeds from the sale, where the proceeds may be a partial refund of the original ticket price paid by the holder, may be a full refund of the original ticket price, or may be more than the original ticket price. The ticket holder may receive the full proceeds from the resale, or a portion of the proceeds.

In some embodiments, a ticket holder may have rights that can be sub-divided into distinct tickets. For example, a ticket holder may have a season ticket that allows entry to multiple events over the course of multiple days (e.g., season tickets for a sports team, season tickets for theater, tickets for each day of a multi-day conference, or a season pass for a ski lift). The ticket holder can release a portion of the rights covered by the season ticket, e.g., tickets to one game played by the sports teams, tickets to one show performed at the theater, tickets for one day of the conference, or lift tickets for one weekend of the ski season. New tickets representing the released portion of the season ticket are then available for distribution. In some embodiments, the ticket holder can designate one or more people to have priority in receiving the tickets. For example, the ticket holder may want clients, customers, friends, or family to have an opportunity to take or purchase the tickets prior to releasing them to other people. In some embodiments, the ticket holder only releases the ticket if it is distributed to someone designated by the ticket holder for receipt. The identified people receive a message inviting them to take or purchase the ticket. In some embodiments, the message is an electronic message sent via e-mail, SMS text message, application notification, or automated telephone call. The message recipients do not need to be in the waiting queue. If none of the identified people respond within a threshold period of time, the ticket is released to the waiting queue. In some instances, e.g., where the event has not sold out or where all ticket requests have been satisfied, there is no queue. In such instances, the ticket holder may be unable to release the ticket or the ticket may be released for distribution responsive to a future request. If the ticket is sold, the ticket holder may receive some or all of the proceeds from the sale. In some embodiments, the original vendor of the season ticket may receive a portion of the proceeds of the sale. For example, the season ticket holder may have received a discount when purchasing the ticket, but the original vendor may require that any resale be at a higher non-discounted price, where the vendor receives the difference. In some embodiments, the season ticket holder makes one or more tickets available to a private list of people, where only people in the private list are able to take the tickets. The season ticket holder can then check the status of any ticket to see if it has been taken by someone on the list. For example, the ticket holder may have a set of tickets to a multi-day event and may offer them to a private list of associates, friends, or family. The ticket holder can then see how many of the tickets in the set have been accepted by people on the private list.

In some embodiments, a season ticket holder resells one or more tickets included in a season ticket package. The ticket holder uses a user device to connect to a tertiary ticket market place server and identifies, for the server, one or more tickets included in the season ticket for resale. For example, the server may provide an interface displaying a list of the tickets held by the season ticket holder (e.g., a list of event dates and seats included in the season ticket) and the ticket holder then selects specific tickets from the displayed list using the interface controls. In some implementations, the ticket holder also identifies an account with a third-party financial institution for receipt of any proceeds (e.g., a credit card, a bank account, etc.). The ticket holder can review the selected tickets and the account information, as well as any other configuration, and confirms. In some implementations, the ticket holder also review and confirms related terms and conditions. After confirmation, the designated tickets are made available for redistribution, e.g., to people waiting in a queue.

In some embodiments, a season ticket holder offers one or more tickets included in a season ticket package to a specific set of people, e.g., associates, friends, or family. The ticket holder uses a user device to connect to a tertiary ticket market place server and identifies, for the server, one or more tickets included in the season ticket for distribution. For example, the server may provide an interface displaying a list of the tickets held by the season ticket holder (e.g., a list of event dates and seats included in the season ticket) and the ticket holder then selects specific tickets from the displayed list using the interface controls. In some implementations, the ticket holder also identifies an account with a third-party financial institution for receipt of any proceeds (e.g., a credit card, a bank account, etc.). The ticket holder selects or identifies a set of people eligible to receive the tickets. In some embodiments, the ticket holder provides contact information (e.g., an email address or mobile phone number) for each person eligible. The server creates a hidden or private queue that identified people can join. The server creates a uniform resource locator (URL) for the private queue and sends it to the identified people with an invitation to join the queue and access the tickets. The invitation includes the URL. The invitation is sent, e.g., by email, text message (to the mobile phone number), or through a custom application. In some embodiments, anyone with the URL can join the private queue. In such embodiments, people who receive the message can forward it to other friends, or share the URL via social media. The ticket holder can review the selected tickets and the account information, as well as any other configuration, and confirm. In some implementations, the ticket holder also review and confirms related terms and conditions. After confirmation, the designated tickets are made available for redistribution through the private queue. In some embodiments, the ticket holder can subsequently remove a ticket that had been made available, if no one has taken it.

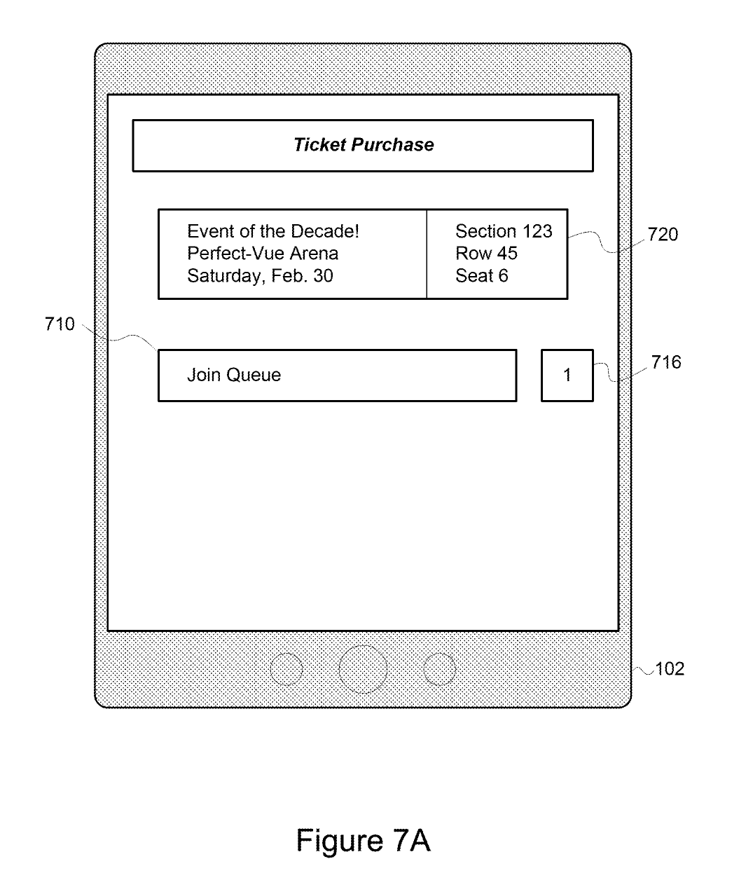

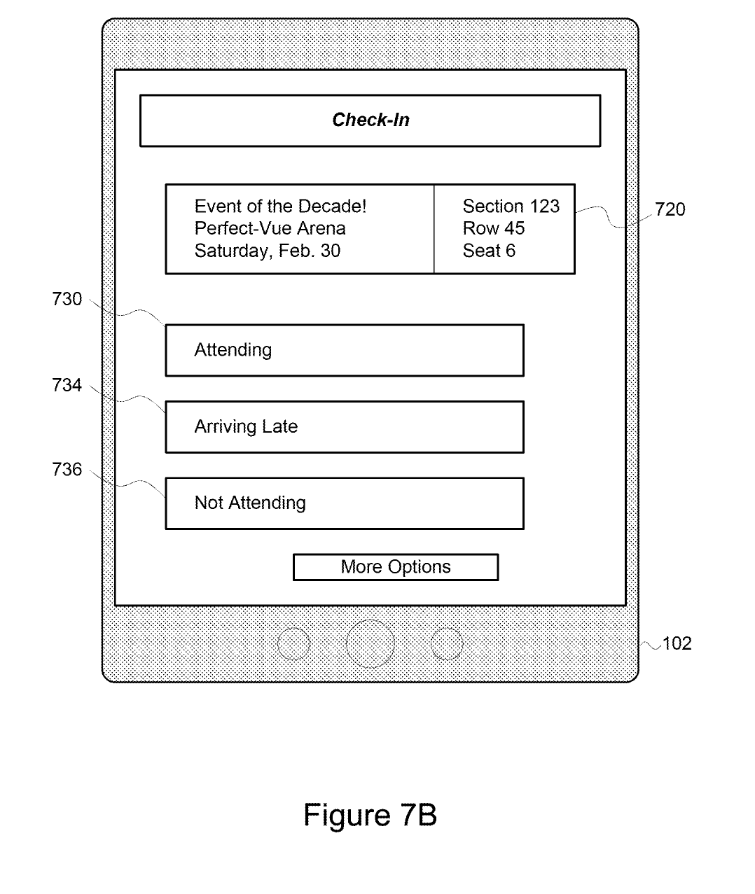

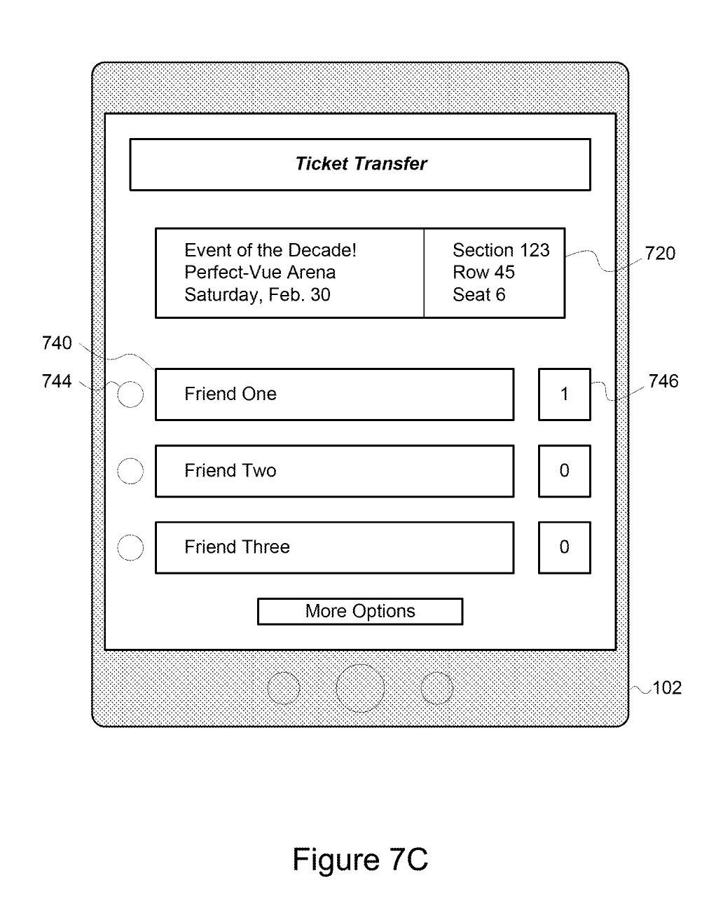

FIGS. 7A-7C are example user interface displays for an example embodiment. FIG. 7A illustrates an example client device 102 displaying a ticket 720 for an event that has been sold out. The user of the client device 102 is presented with an interface providing the option 710 to join the queue. In some embodiments, the user may require multiple tickets, and the illustrated interface provides a field 716 for entering the desired number of tickets. FIG. 7B illustrates an example client device 102 displaying a ticket 720 for an event and requesting confirmation that a purchaser will attend the event. The user may, for example, select the option 730 for “Attending” to indicate that are planning to come to the event. The user may, for example, select the option 734 for “Arriving Late” to indicate that are planning to come to the event, but do not expect to be there by the event start time (or some preferred arrival time, e.g., fifteen minutes before the event start time). In some embodiments, selection of the “Attending” option 730 or the “Arriving Late” option 734 generates an “I'm Coming” message as described above. The user may, for example, select the option 736 for

“Not Attending”. Selecting this option may result in a cancelation of the user's tickets. In some embodiments, as described above in reference to FIG. 4, the user may be able to transfer the tickets to a friend. FIG. 7C illustrates an example client device 102 displaying a menu for selecting friend 740 to receive the displayed ticket 720. The user can select a check box or radio button 744 to select the recipient. If the user has multiple tickets to the event, the user can select a number of tickets to transfer 746. The displays shown in FIGS. 7A-7C are example displays. Other interfaces are within the scope of this disclosure.

FIG. 8 is a block diagram of a computing system 810 suitable for use in implementing the computerized components described herein. The elements of a computing system generally include a processor for performing actions in accordance with instructions and one or more memory devices for storing instructions and data. The illustrative computer system 800 includes one or more processors 850 in communication, via a bus 815, with one or more network interface controllers 920 (e.g., for communication with an external network device 824 via a network interface 822), optional I/O interfaces 930 (e.g., for interacting with a user or administrator), and memory 870. Generally, a processor 850 will receive instructions and data from a read only memory or a random access memory or both. The processor 850 illustrated incorporates, or is directly connected to, additional cache memory 875. In some uses, additional other components 880 are in communication with the computer system 810, e.g., external devices connected via a universal serial bus (USB). In some uses, such as in a server context, there is no I/O interface 830 or the I/O interface 830 is not used. In some uses, the I/O interface 830 supports an input device and/or an output device (not shown). In some uses, the input device and the output device are integrated into the same hardware, for example, as in a touch screen.

In some implementations, the client devices 102 illustrated in FIG. 1 are constructed to be similar to the computer system 810 of FIG. 8. For example, a user interacts with an I/O interface 830 input device, e.g., a keyboard, mouse, or touch screen, at a client device 102 to access an interface, e.g., a web page, over the network 104. The interaction is received at the client device's network interface 822, and responses are output via an I/O interface 830 output device, e.g., a display, screen, touch screen, or speakers for presentation to the user.

In some implementations, one or more of the servers and marketplaces illustrated in FIG. 1 are constructed to be similar to the computer system 810 of FIG. 8. In some implementations, a server may be made up of multiple computer systems 810. In some implementations, a server may be a virtual server, for example, a cloud based server. A server may be made up of multiple computer systems 810 sharing a location or distributed across multiple locations. The multiple computer systems 810 forming a server may communicate using the user-accessible network 104 (which may include multiple network devices 824).

The processor 850 may be any logic circuitry that processes instructions, e.g., instructions fetched from the memory 870 or cache 875. In many embodiments, the processor 850 is a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 810 may be based on any of these processors, or any other processor capable of operating as described herein. The processor 850 may be a single core or multi-core processor. The processor 850 may be multiple processors.

Additional interfaces 880 support connection of additional peripheral devices to the computing system 810. The peripheral devices may be connected physically, e.g., via FireWire or universal serial bus (USB), or wirelessly, e.g., via Bluetooth. Examples of peripherals include keyboards, pointing devices, display devices, braille terminals, audio devices, hubs, printers, media reading devices, storage devices, hardware accelerators, sound processors, graphics processors, antennae, signal receivers, sensors, measurement devices, and data conversion devices. In some uses, peripherals include a network interface and connect with the computer system 810 via the network interface 822. For example, a printing device may be a network accessible printer.

The computing device 810 may include a network interface 822 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). The interface 822 may include an antennae and/or a radio transmitter and receiver.

The computing devices typically operate under the control of operating systems, which control scheduling of tasks and access to system resources. The computing device can be running any operating system such as any of the versions of the MICROSOFT WINDOWS operating systems, the different releases of the Unix and Linux operating systems, any version of the MAC/OS for Macintosh computers, any embedded operating system, any real-time operating system, any open source operating system, any proprietary operating system, any operating systems for mobile computing devices (e.g. Android or iOS), or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system has sufficient processor power and memory capacity to perform the operations described herein. For example, the computer system may comprise a device of the IPOD, IPAD, or IPHONE families of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

In some embodiments, the computing device is a digital audio player. In one of these embodiments, the computing device is a digital audio player such as the Apple IPOD, IPOD Touch, IPOD NANO, and IPOD SHUFFLE lines of devices, manufactured by Apple Computer of Cupertino, Calif. In another of these embodiments, the digital audio player may function as both a portable media player and as a mass storage device. In other embodiments, the computing device is a digital audio player such as the DigitalAudioPlayer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device is a portable media player, such as the ZEN VISION W, the ZEN VISION series, the ZEN PORTABLE MEDIA CENTER devices, or the Digital MP3 line of MP3 players, manufactured by Creative Technologies Ltd. In yet other embodiments, the computing device is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

### EXAMPLES

The following examples are meant to be illustrative and in no way limiting of the inventions described in this document. This section presents high level user stories and example scenarios for how people may experience the disclosed systems and methods.

In one example, a user downloads and installs an application onto a mobile device, e.g., a smartphone or tablet. On the first opening of the application, there are two buttons displayed: “Ticket Holder” and “Ticket Seeker.” The user can select “Ticket Holder” to indicate that the user has one or more tickets to an event. Upon selecting “Ticket Holder,” the user will be let to an “I'm coming” page where the user can either confirm an intent to attend the event or notify the ticket manager that the user is not intending to attend the event. Alternatively, the user can select the “Ticket Seeker” option to join a queue waiting for released or canceled tickets. In some implementations, the application shows these two options prior to identifying the user or an event the user is interested in. When the user selects “Ticket Holder,” the user may be asked to identify the event, e.g., by scanning the ticket or entering a ticket serial number. When the user selects “Ticket Seeker,” the user may be asked to enter details of the event the user wants to attend. If tickets are available for the event, the user may be directed to a purchase interface. If tickets are not available for the event, the user may be offered the opportunity to join the queue and may be asked for bank or credit card information. In some embodiments, a hold is placed on the user's credit card for the transaction amount of a ticket transfer.

In some embodiments, the user begins the interactions with the user interface prior to presenting a login credential. The user may already have an account with the ticket manager, which can be associated with the user's client device. The user may be asked to create an account when the user reaches a decision point requiring identification of the user. An account may be associated with identification information for the user (e.g., name, address, etc.), contact information for the user (e.g., email address, telephone or mobile-phone number), and billing information (e.g., credit card number and expiration). The user may be required to verify the registration information.

In some embodiments, when the user opens the application, the user is shown a list of upcoming events for which the user has already purchased/registered/requested tickets, either as a ticket holder or a ticket seeker.

In some embodiments, the user is directed to a portal with a three button page: “New Ticket Holder”, “New Ticket Seeker” and “Already registered?”. The first two have the behavior described above. The “Already Registered?” option leads the user to a login page and with “Sign In” and “Forgotten Password” links. In some embodiments, web browser cookies allow the user's client device to be associated with the login info and the user session is immediately opened without password whenever possible. Users can log out and then be presented a login page. When the User logs in the user is directed to a page with a list of upcoming events for which the user has tickets or is waiting for tickets in the queue. In some embodiments, the user is shown a list of upcoming events near the user or similar to events the user has previously attended.

When the event starts, the Ticket Holders who have registered their ticket and not arrived or pre-emptively checked-in are notified that their tickets will be scratched at a specified time unless they activate the “I'm coming” option. In some embodiments, the user is provided the option of submitting the “I'm coming” message through the custom application, through a web site, by sending an SMS text with a specific code to a specific number, or by calling a telephone number and interacting with either an operator or a telephone user interface (TUI).

In some embodiments, a user who's tickets have been canceled receives an invitation to a secondary venue near the main venue. The secondary venue may include a television or projection display of the event and may include additional attractions to simulate attendance at the main event. In some embodiments, persons present at a secondary venue are placed in a queue for receiving passes to the main event. In some embodiments, persons in a secondary venue may receive passes after the event has started either at a discount, or for free.

In some embodiments, the user may attempt to confirm intent to attend before an acceptable date. For example, users may be required to confirm intent to attend no earlier than one week before the event, or the day of the event. If it is before the acceptable time, the user may receive feedback regarding the event and a notice that they have not confirmed an intent to attend.

In some embodiments, a user on the queue may request to be removed from the queue. For example, a user may no longer be able to attend the event. In some embodiments, a user who exits the queue without receiving a ticket is not charged. In some embodiments, a user is charged a small handling fee for entry into the queue, and this fee is not returned, but the user is not charged for tickets the user did not receive.

In some embodiments, a user whose ticket is canceled and subsequently resold receives a refund of all or part of the original ticket price. For example, a user determines that she is unable to attend an event and submits an “I'm not coming” message as described above. The ticket is then sold to another user, e.g., a user in the queue. The original ticket holder is then given a refund of some amount. The refund amount may be the original ticket purchase price with, or without, associated transaction fees. The refund amount may be higher than the original ticket purchase price, e.g., if the ticket was sold for an amount higher than the original ticket purchase price. The refund amount may be less than the original ticket purchase price, e.g., if the ticket was sold for an amount less than the original ticket purchase price.

In some embodiments, a user who is placed in a waiting queue may provide a range for the number of tickets desired and/or the price the user is willing to pay. In some such embodiments, the user can enter a price that is higher than the original ticket purchase price. In some embodiments, if a user is willing to pay a higher price, the user may receive priority in the queue. The user is not charged more than the user indicates that he or she is willing to pay. In some embodiments, a user may indicate that they are not willing to pay full price and the user may be sold the ticket at the discounted price, if necessary, to fill the venue. That is, in some embodiments, an event organizer may prioritize filling the venue over charging full ticket price.

In some embodiments, when a user is placed in a waiting queue for tickets, the user may receive an indicator of where the user is in the queue and how likely the user is to receive tickets. In some embodiments, the user receives an indication of how likely the user is to receive tickets prior to an event start time and/or how likely he or she is to receive tickets after the event start time.

In some embodiments, the likelihood that a user in the queue will receive a ticket is determined as follows: The ticket manager is configured with a history of previous events, from which an expected available seats value is calculated. For example, in some embodiments, the expected available seats value is a percentage (e.g., 50%) of the average number of empty seats from past similar events in the history. A similar event may be an event of the same type (e.g., sport, concert, theater, etc.), at the same venue (or similar venue size, or similar venue location, or both), at the same time of year or day of week. The number of people in the queue less than the expected available seats value (or slightly less, e.g., 95% of the expected available seats value) receive an indicator that they are highly likely to obtain admission to the event. The remaining people in the queue receive indicators that they are less likely to obtain admission to the event. In some embodiments, the indicators are colors, e.g., Green for highly likely, Yellow for likely (e.g., within 120% of the expected available sears value, but not Green), and Red for unlikely (e.g., deeper in the queue than the Green or Red).

In some embodiments, a Ticket Seeker can see a list of upcoming events, each event shown with an indicator for its respective queue. In some embodiments, the list is a list of events for which the user has entered the queue. In some embodiments, the list is a list of events for which the user might be interested. In some embodiments, a user in a queue is given the option of withdrawing from the queue.

In some embodiments, a user with a high probability of acquiring a ticket may have a different experience that a user with a low probability of acquiring a ticket. For example, if the probability is above a threshold, the system may determine that the user will probably be able to get a ticket and will provide additional accommodations to facilitate that process. If the probability is below the threshold, the system may determine that the user will not get a ticket, and identify alternative options for engaging the user. For example, a user who is unable to obtain a ticket to an event that includes a performance by a specific entertainer may be a fan of the specific entertainer, and may be interested in obtaining tickets to other events that include performances by the specific entertainer. The system may provide the user with early access to tickets for a later event as a consolation for not being able to obtain tickets to the first event.

In some embodiments, a user in a queue that is highly likely (or reasonably likely) to receive a ticket is sent a notification (notification through the application, through email, through SMS text message, and/or through an automated telephone call) that his or her place in the queue gives a good probability to get a ticket and that the user should now secure that possibility by providing billing (e.g., credit card or PayPal) info for use in purchasing a ticket as soon as one would become available for them. A hold may be placed using the billing info provided. The user is warned that after confirmation they will not be able to quit the queue and that the ticket will be bought as soon as it becomes available without possibility to refuse it. If the Ticket Seeker refuses to confirm (or do not answer after one or more attempts covering the confirmation period), the user is removed from the queue (or demoted within the queue). In some embodiments, the user receives a confirmation email or notification.

In some embodiments, a user (a “Ticket Seeker”) who is granted a ticket, is notified on his/her smart phone (and SMS and/or email according to the user's preferences stored in a profile setting) that the ticket is available for him in the application. In some implementations, the ticket is displayed with a bar code or QR code that can be scanned at the venue admissions gate. In some implementations, the user is emailed an image or document with the ticket embodied therein. In some implementations, the user can print the ticket image or document.

In some embodiments, a user in a waiting queue who did not receive a ticket to an event is notified that there are no tickets available. In some embodiments, the user is invited to a secondary venue. In some embodiments, the secondary venue is supplemental to the venue of the main event. For example, the supplemental venue may be a near-by space hosting a video replay of the event. If a person at the supplemental venue is able to get a ticket to the primary venue, the close proximity facilitates getting to the primary venue quickly. In some embodiments, the secondary venue is for another event at another time, which might or might not include one or more performers from the primary event.

In some embodiments, a user in a waiting queue may receive offers related to the event. For example, a user in a waiting queue to attend an event that includes a performance by a particular performer may receive offers to attend other performances by the particular performer, offers to attend performances by performers similar to the particular performer, offers to purchase media featuring the particular performer, offers to join a mailing list, or offers to purchase clothing, bags, or other memorabilia related to the particular performer. In some embodiments, a user in a waiting queue may receive a voucher for early access to tickets for another event, e.g., a future instance of the event.

In some embodiments, users may join a waiting queue to receive items with limited availability. For example, a company may offer to provide over-stock of items to users who are in a waiting queue. The company might not know how many of the item will be available in overstock when users join the queue, but may provide a prediction such that users who enter the queue below the predicted threshold may receive an indication of a high probability that they will receive the item, while users who enter the queue above the predicted threshold may receive an indication of a low probability that they will receive the item. In some embodiments, the prediction may be updated. When the prediction is updated, users may receive an updated indication of their respective probabilities. In some embodiments, the over-stocked items are retail items, limited edition items, give away items, gift items, time-limited items, or corporate branding items.

In some embodiments, users may join a waiting queue to obtain a reservation for a hotel, restaurant, transit (air, bus, train, ferry, etc.), or rental vehicle. For example, a user may request a room at a hotel satisfying certain criteria (e.g., having two beds). If the reservation request cannot be satisfied, the user may be added to a waiting queue in case a reservation is canceled, making a suitable room available. In some such implementations, a user in the waiting queue may receive offers to accept an alternative reservation. For example, a user waiting for a room with two beds might receive an offer for two rooms each with one bed, at the same or similar price. As another example, a user waiting for a room at a first hotel may receive an offer for a comparable room at a near-by hotel.

In some embodiments, an event organizer may distribute tickets through multiple channels. For example, an event sponsor may receive a set of tickets to distribute separately from other tickets for the event. A sponsor can then invite people to join a queue to receive the tickets allocated to the sponsor, regardless of if the event is sold out. For example, a company may sponsor a section at a concert and host a give-away for tickets to sit in that section. People request tickets in the sponsored section and are entered into a waiting queue with some probability of receiving the tickets. As another example, a company may make tickets available to employees by establishing a private queue for employees.

In some embodiments, a user may request tickets to an event before tickets to the event have been made available to the public. The event organizer may then distribute some number of tickets through the queue. An event organizer may prefer this as the queue demonstrates a level of demand for the event. People willing to enter the queue may receive a reward such as reduced cost for the tickets, preferred seating at the event, or additional materials such as t-shirts, bags, or hats advertising the event.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments, it will now become apparent to one of skill in the art that other embodiments incorporating the concepts of the disclosure may be used. Therefore, the disclosure should not be limited to certain embodiments, but rather should be limited only by the spirit and scope of the following claims.

1-42. (canceled)

43. A method comprising:
determining, from a rights database storing rights allocation information, that a first right is allocated to a first party;
receiving, by a server from a client device controlled by a second party, a request that can be at least partially satisfied by reallocating the first right from the first party to the second party;
calculating, by the server, a probability that the request will be satisfied;
providing, to the client device, an indicator of the calculated probability;
recording, in a request database storing rights request information, a record of the request;
determining, after recording the record of the request, that the first party has released the first right; and
updating the rights database to reallocate the first right from the first party to the second party.

44. The method of claim 43, wherein the first right includes one or more of:
a right for access an event venue;
a right to enter an access-controlled space;
a right to park a car in a parking lot;
a right to use one or more specified seats for a specified period of time;
a right to acquire additional rights;
a right to receive an item; and
a right to make a specified purchase.

45. The method of claim 43, comprising:
adding, responsive to receiving the request, an identifier for the second party to a queue at a position in the queue; and
calculating the probability based at least on the position in the queue.

46. The method of claim 43, comprising receiving a confirmation, from the client device, that the second party intends to exercise the first right.

47. The method of claim 43, wherein determining that the first party has released the first right comprises receiving, from the first party, an express indicator that first party has released the first right.

48. The method of claim 43, wherein determining that the first party has released the first right comprises:
sending, to the first party, a request to confirm that the first party will exercise the first right by a specified time; and
determining that the first party has not exercised the first right after the specified time has passed.

49. The method of claim 48, wherein the first right includes an access right to an event with an event start-time, and the specified time is at or after the event start-time.

50. The method of claim 48, wherein the first right includes an access right to an event with an earliest entry-time and a subsequent event start-time, and the specified time is between the earliest entry-time and the event start-time.

51. The method of claim 43, comprising:
determining that the calculated probability is above a threshold value;
requesting, responsive to determining that the calculated probability is above the threshold value, that the second party provide authorization to execute a financial transaction if selected to receive the first right; and
executing the financial transaction prior to updating the rights database to reallocate the first right from the first party to the second party.

52. The method of claim 43, comprising:
notifying the first party, responsive to successfully updating the rights database, that the first right has been revoked; and
notifying the second party, responsive to successfully updating the rights database, that the first right has been allocated to the second party.

53. The method of claim 52, wherein notifying the first party comprises one or more of:
calling a telephone number associated with the first party and playing a pre-recorded message;
sending an electronic message to an e-mail address associated with the first party;
sending a text message to the telephone number associated with the first party;
sending a notification event to an application executing on a client device controlled by the first party; and
transmitting ticket information to the client device controlled by the second party.

54. The method of claim 43, wherein determining that the first party has released the first right comprises receiving, from the first party, one of:
a transfer request to reallocate the first right from the first party to the second party, or
a transfer request to reallocate the first right from the first party to a specified set of people that includes the second party.

55. The method of claim 43, wherein the first right includes a right to access a venue, the method comprising:
transmitting ticket information to the client device controlled by the second party; and
accepting presentation of the ticket information from the client device at an access point for the venue.

56. A system comprising:
a computer processor configured for network communication;
one or more memory elements accessible by the computer processor, the memory elements storing a rights database of rights allocation information and a request database storing rights request information; and
a computer-accessible memory storing instructions that, when executed by the computer processor, cause the computer processor to:
determine, from the database storing rights allocation information, that a first right is allocated to a first party;
receive, from a client device controlled by a second party, a request that can be at least partially satisfied by reallocating the first right from the first party to the second party;
calculate a probability that the request will be satisfied;
provide, to the client device, an indicator of the calculated probability;
record, in the request database, a record of the request;
determine, after recording the record of the request, that the first party has released the first right; and
update the rights database to reallocate the first right from the first party to the second party.

57. The system of claim 56, wherein the first right includes one or more of:
a right for access an event venue;
a right to enter an access-controlled space;
a right to park a car in a parking lot;
a right to use one or more specified seats for a specified period of time;
a right to acquire additional rights;
a right to receive an item; and
a right to make a specified purchase.

58. The system of claim 56, the computer-accessible memory further storing instructions that, when executed by the computer processor, cause the computer processor to:
add, responsive to receiving the request, an identifier for the second party to a queue at a position in the queue; and
calculate the probability based at least on the position in the queue.

59. The system of claim 56, the computer-accessible memory further storing instructions that, when executed by the computer processor, cause the computer processor to receive a confirmation, from the client device, that the second party intends to exercise the first right.

60. The system of claim 56, wherein the computer-accessible memory further storing instructions that, when executed by the computer processor, cause the computer processor to determine that the first party has released the first right by:
sending, to the first party, a request to confirm that the first party will exercise the first right by a specified time; and
determining that the first party has not exercised the first right after the specified time has passed.

61. The system of claim 56, wherein the computer-accessible memory further storing instructions that, when executed by the computer processor, cause the computer processor to:
determine that the calculated probability is above a threshold value;
request, responsive to determining that the calculated probability is above the threshold value, that the second party provide authorization to execute a financial transaction if selected to receive the first right; and
execute the financial transaction prior to updating the rights database to reallocate the first right from the first party to the second party.

62. The system of claim 56, the computer-accessible memory further storing instructions that, when executed by the computer processor, cause the computer processor to:
notify the first party, responsive to successfully updating the rights database, that the first right has been revoked; and
notify the second party, responsive to successfully updating the rights database, that the first right has been allocated to the second party.

63. The system of claim 62, wherein the computer-accessible memory further storing instructions that, when executed by the computer processor, cause the computer processor to notifying the first party by one or more of:
calling a telephone number associated with the first party and playing a pre-recorded message;
sending an electronic message to an e-mail address associated with the first party;
sending a text message to the telephone number associated with the first party; and
sending a notification event to an application executing on a client device controlled by the first party.

64. The system of claim 56, wherein the computer-accessible memory further storing instructions that, when executed by the computer processor, cause the computer processor to determine that the first party has released the first right responsive to receiving, from the first party, a transfer request to reallocate the first right from the first party to the second party or to a specified set of people that includes the second party.

65. The system of claim 56, wherein the computer-accessible memory further storing instructions that, when executed by the computer processor, cause the computer processor to notify the second party by transmitting ticket information to the client device controlled by the second party.

66. The system of claim 56, wherein the first right includes a right to access a venue, the computer-accessible memory further storing instructions that, when executed by the computer processor, cause the computer processor to accept presentation of the ticket information from the client device at an access point for the venue.
